(19) United States
(12) Patent Application Publication
(10) Pub. No.: US 2014/0125047 A1
(43) Pub. Date: May 8, 2014

(54) Refill for Stationery Item, and Stationery Item Comprising Such a Refill

(71) Applicants: Emeric Philippe Marie Thibierge, Asnieres (FR); Patrice Girona, Lamorlaye (FR)

(72) Inventors: Emeric Philippe Marie Thibierge, Asnieres (FR); Patrice Girona, Lamorlaye (FR)

(73) Assignee: Aleris Rolled Products Germany GmbH, Koblenz (DE)

(21) Appl. No.: 14/127,881

(22) PCT Filed: Jun. 21, 2011
(86) PCT No.: PCT/FR2011/051420

§ 371 Date: Dec. 19, 2013

(51) Int. Cl. B42B 5/00

(52) U.S. Cl. CPC B42B 5/00
USPC 281/27.3

(57) ABSTRACT

The invention relates to a stationery item comprising a cover (2) and removable contents forming a refill. The refill comprises: a block (6) of stacked pages forming two main outer surfaces (6a, 6b) separated by a certain thickness; a binding (7) that binds the pages of the block together at the back (6c) of the block; and a flexible covering strip (8) that covers the binding. The covering strip includes: a back portion which outwardly covers the binding and which is provided with magnetic elements (9a-9b), and two side portions that are attached to both of the main surfaces of the block, respectively. The refill can be removably attached to the back (2c) of the cover which includes built-in magnetic means (3a, 3b) for attracting the magnetic elements (9a-9b) of the refill.

### FIELD OF THE INVENTION

The present inventions concerns refills for stationery items, and stationery items comprising such refills.

In general, the invention relates to the field of stationery items with a cover and removable contents, which allows for example changing the contents while keeping the protective cover. These items can be ledgers, notebooks, notepads, appointment books, or other items, of any format.

More specifically, the invention relates to a refill for a stationery item, comprising:
a pad (or “block”) of pages, comprising a plurality of stacked pages, said pad of pages forming:
   two main outer surfaces separated by a certain thickness,
   a spine (or “back”) defining said thickness at one side of the pad,
a binding that binds the pages of the pad together at the spine of the pad,
magnetic means, arranged at the spine of the pad and adapted to attach by magnetic attraction to a cover of the stationery item.

### TECHNOLOGICAL BACKGROUND OF THE INVENTION

Document WO 2007/127451 describes a refill of this type, which attaches by magnetic attraction to the inside face of the spine of a protective cover. The spine of the refill described in this document comprises a magnetic element which can stiffen the binding of the pad of pages and make it more difficult to open the pages. This difficulty in opening the pages may lead the user to force them open by pressing on the central portion of the refill, which may damage the refill.

### OBJECTS OF THE INVENTION

The present invention is intended to overcome some or all of these disadvantages.

To this end, the invention proposes a refill of the above type which further comprises a flexible covering strip having:
a spine portion (or “back portion”) which externally covers the binding, and
two side portions which are respectively attached to the two main surfaces of the pad of pages and are connected to the spine portion,
   the spine portion of the covering strip being provided with said magnetic means.

Due to this covering strip, the magnetic means are separate from the refill binding and therefore they do not or they only slightly increase the difficulty of opening the pages of the refill.

In various embodiments of the refill according to the invention, one or more of the following arrangements may be used:
the magnetic means comprise a ferromagnetic material;
said ferromagnetic material is permanently magnetized;
said ferromagnetic material is a metal;
the covering strip is less than 1 mm in thickness, preferably less than 0.5 mm;
the magnetic means comprise at least one magnetic element integral with the spine portion of the covering strip;
the spine portion of the covering strip has a certain thickness and said magnetic element is included within said thickness;
said magnetic element is attached to the spine portion of the covering strip facing the binding of said pad;
the spine portion of the covering strip is integral with at least two magnetic elements spaced apart along the spine of the refill;
the magnetic elements are arranged asymmetrically on the spine of the refill relative to a 180° rotation of the refill about an axis perpendicular to the spine of the refill;
the magnetic elements are permanent magnets with non-parallel polarization relative to each other;
the magnetic means comprise at least one magnetic material integrated into the material of the spine portion of the covering strip;
each of the two side portions of the covering strip comprises:
   a free and flexible intermediate portion which extends laterally from the spine portion and is not attached to the corresponding main surface of the pad of pages,
   and an end portion which extends from said intermediate portion and is attached to said corresponding main surface of the pad of pages (this is a particularly good arrangement for allowing the pages to open);
the spine portion of the covering strip has a certain width and the magnetic means comprise at least one rigid magnetic element which extends over a width that is less than the width of the spine portion, the spine portion having two free and flexible side strips which are not covered by said magnetic element and which connect to said side portions of the covering strip (this is a particularly good arrangement for allowing the pages to open).
   The invention also relates to a stationery item comprising:
a refill as defined above,
a cover comprising at least a front cover board, a back cover board, and a spine connecting the front and back cover boards, the spine being provided with magnetic means adapted for attracting the magnetic means of the refill.

In various embodiments of the stationery item of the invention, one or both of the following arrangements may be used:
the magnetic means of the refill comprise at least one magnetic element integral with the spine portion of the covering strip and the spine of the cover comprises at least one complementary magnetic element adapted for magnetically attracting the magnetic element of the refill and arranged in correspondence with said magnetic element of the refill;
the magnetic means of the refill comprise a plurality of magnetic elements integral with the spine portion of the covering strip and the spine of the cover comprises a plurality of complementary magnetic elements each adapted for magnetically attracting a magnetic element of the refill and arranged in correspondence with said magnetic element of the refill.

### BRIEF DESCRIPTION OF DRAWINGS

Other features and advantages of the invention will become apparent from the following description of several of its embodiments, given by way of non-limiting examples, with reference to the accompanying drawings in which:

FIG. 1 is a perspective view showing a stationery item according to a first embodiment of the invention;

FIG. 2 is a side view showing the spine of the refill of the stationery item shown in FIG. 1;

FIG. 3 is a cross-sectional view of an item according to the invention in its completely closed position;

FIG. 4 is a detail view showing the spine of the stationery item shown in FIG. 3;

FIG. 5 is a perspective view of a transverse cross-section, showing the stationery item of FIGS. 1-4 in an open position;

FIG. 6 is a detail view showing the spine of the stationery item of FIG. 5;

FIG. 7 shows an enlargement of part of FIG. 6;

FIG. 8 is a perspective view showing a stationery item according to a second embodiment of the invention;

FIGS. 9 and 10 are sectional views of the refill according to second and third embodiments, in the open position.

### DETAILED DESCRIPTION

The same references are used to denote identical or similar elements in the different figures.

### First Embodiment

The invention relates to a stationery item 1 of which a first embodiment is shown in FIG. 1.

This stationery item 1 may be a notebook or similar item which includes a cover 2 and a refill 6.

The cover 2 comprises:
a front cover board 2a,
a back cover board 2b,
and a spine 2c defining the thickness of the stationery item 1, this spine 2c being respectively connected to the cover boards 2a, 2b by two hinges 2d formed for example as two thinned lines in the cover 2 and extending on either side of and along said spine 2c.

Optionally, each of the cover boards 2a, 2b may be extended, at its edge opposite the spine 2c, by a hinged flap 2e connected to the corresponding cover board by a hinge 2f formed for example as a thinned line in the cover 2.

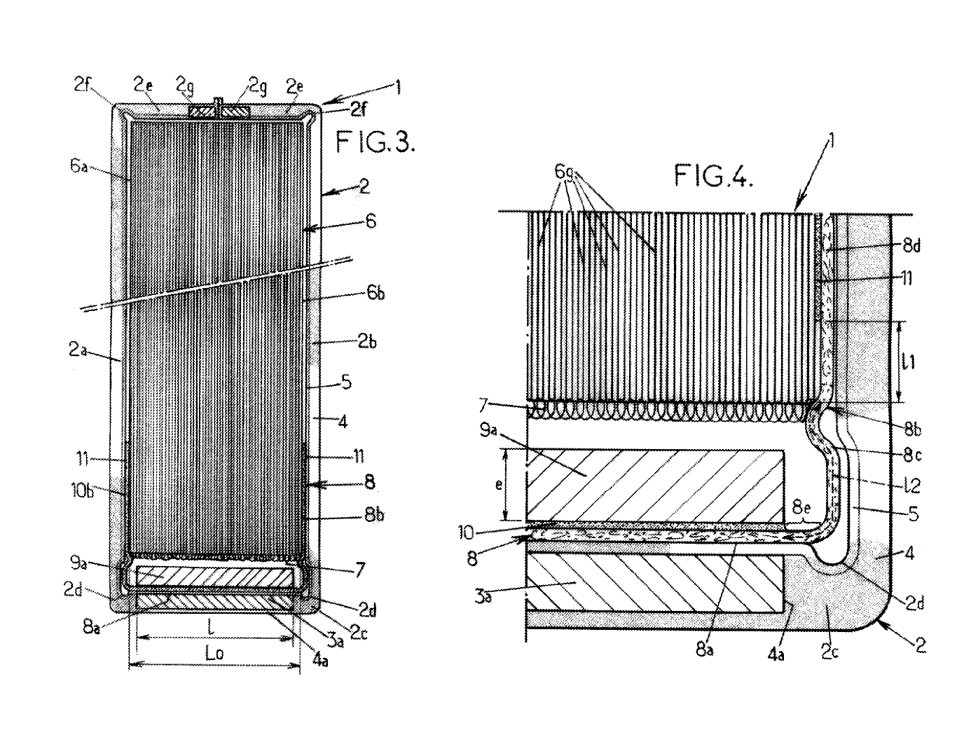

As shown in FIG. 3, the flaps 2e can each have a width equal to about half the thickness of the stationery item 1 and can be folded towards each other to 90° relative to the cover boards 2a, 2b so as to come into mutual contact, edge to edge, when the stationery item 1 is closed. The flaps 2e may contain permanent magnets 2g or other magnetic elements, which are arranged to be facing one another from one flap 2e to the other and which are adapted to attract one another and keep the edges of the flaps 2e against each other by magnetic attraction when the item 1 is in the closed position. When the item 1 is in the open position, the flaps can unfold to lie flat as an extension of the cover boards 2a, 2b.

The inside face of the spine 2c of the cover 2 is provided with magnetic means which, in the example considered here, may consist of one or more permanent magnets, for example two permanent magnets 3a, 3b in the embodiment shown (see FIG. 1).

The cover 2 may be created in any known manner, of rigid or flexible material. For example, said cover 2 may include a thick outer layer 4 made for example of cardboard or other material, possibly covered with an outer covering of leather, textile, paper or other material (not shown), this thick layer 4 also being covered with an inner lining 5 of paper or other material. The inner lining is relatively thin, for example 0.5 mm or less. In the example shown, said magnets 3a, 3b can be glued into recesses 4a in the thick layer 4 and covered on the inside surface of the item 1 by the inner lining 5, which is in contact with said magnets. Of course, the magnets 3a, 3b can be attached in any other manner to the inside face of the spine 2c of the cover 2.

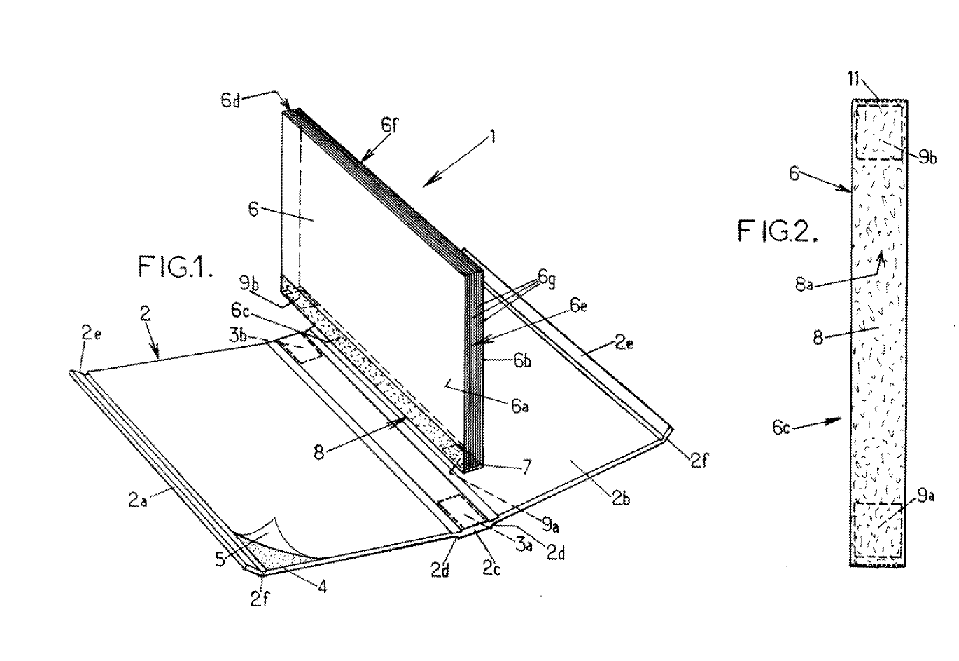

As shown in FIGS. 1 and 2, the stationery item 1 also comprises a refill 6, forming a pad of sheets of paper 6g stacked and assembled together by a binding 7. The refill 6 has:
a main front face 6a and a main back face 6b, formed for example by sheets of paper which are identical to the other sheets 6g or are thicker,
and four edges 6c-6f defining the thickness of the refill 6, these edges comprising a spine 6c, an upper edge 6d or top edge, a lower edge 6e or bottom edge, and an edge 6f opposite the spine, called the front edge.

As shown in FIGS. 1-3, the pages 6g of the refill 6 are joined together by a binding 7 at the spine 6c of the refill. This binding 7 may be of any known type; it may for example comprise a glued cloth attached by adhesive bonding and possibly stitching along the spine 6c edge of the pages 6g.

The refill 6b further includes a relatively thin flexible covering strip 8 (for example less than 1 mm thick, preferably about 0.5 mm or less) which covers the outside of the binding 7 and at least a portion of the main front and back faces 6a, 6b. This covering strip 8 may consist for example of cloth or paper or other material.

In the example shown, the covering strip 8 more specifically comprises:
a spine portion 8a covering the binding 7 on the outside, and
two side portions 8b respectively attached, by adhesive bonding or other means, to the two main surfaces 6a, 6b, of the pad of pages 6g, and connected to the spine portion 8a.

The spine portion 8a of this covering strip 8 incorporates magnetic means which are adapted to be attracted by the magnetic means of the spine 2c of the cover 2, enabling removable attachment of the refill 6 to the cover 2. In the example shown in FIGS. 1 to 3, the magnetic means of the covering strip 8 are permanent magnets 9a, 9b which are arranged opposite the permanent magnets 3a, 3b of the cover and which have polarities arranged so that the corresponding magnets 3a, 3b and 9a, 9b attract one another by magnetic attraction.

Of course, the magnets 9a, 9b may be replaced by any other part of ferromagnetic material, whether permanently magnetized or not, for example metal parts or magnetic materials obtained by mixing adhesives with powder containing magnetic particles or based on a ferrous metal, or a combination thereof.

The arrangement of the magnets 9a, 9b may optionally be asymmetric relative to a rotation of the refill about an axis perpendicular to the spine 6c, meaning relative to a rotation of the refill 6 that reverses the top edge 6d and the bottom edge 6e. In this case, the magnets 3a, 3b or the other magnetic elements of the cover 2 are also arranged asymmetrically, in correspondence with the magnets 9a, 9b. This foolproof arrangement forces the user to place the refill 6 in the proper direction inside the cover 2, particularly when the pages 6g of the refill contain information that assumes a predefined orientation of the pages 6g (for example if the item 1 is an appointment book or similar item).

Alternatively or additionally, it is possible to achieve such foolproofing by orienting the polarities of the magnets 9a, 9b differently from one magnet to the other (for example by inverting the polarity between magnets 9a and 9b) so that the attachment by magnetic attraction is achieved in only one position of the refill 6 relative to the cover 2. Of course, in this case, the polarities of the magnets 3a, 3b are arranged so that a north pole of one magnet 3a, 3b respectively corresponds to the south pole of the corresponding magnet 9a, 9b.

By way of non-limiting example, the magnets 3a, 3b, 9a, 9b may be parallelepipedal in shape and may be magnetized in the longitudinal direction (the longitudinal direction of the spine 6c), although the magnets may have a different shape (for example an oblong or circular disk).

The arrangement of the magnets 9a, 9b in the refill 6 will now be further described in relation to FIGS. 1-7.

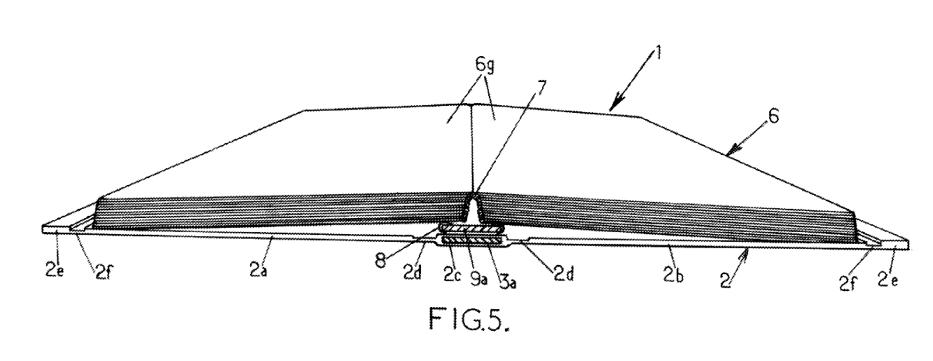

The magnets 9a, 9b are, for example, glued by a layer of adhesive 10 to the inside of the spine portion 8a of the covering strip 8, facing the binding 7, as can be seen in the more detailed view in FIGS. 3 and 4, without adhering to the pages 6g of the pad or to its binding 7. A space of a few millimeters can potentially be left between the magnets 9a, 9b and binding 7. Because the magnets 9a, 9b or other magnetic means are incorporated into the covering strip 8 and in particular are arranged on the inner face of its spine portion 8a, these magnetic means are easily attached to the refill in a very reliable manner at a low cost and without interfering with opening the pages 6g of the refill.

When the refill 6 is attached to the cover 2, magnets 9a, 9b are only separated from magnets 3a, 3b by the thickness of the covering strip 8, inner lining 5, and adhesive layer 10, totaling less than 1.2 mm for example, or even less than 1 mm, between magnets 3a, 3b and the corresponding magnets 9a, 9b.

Each of the magnets 9a, 9b or similar magnetic elements extends here for a width I which is between for example 60 and 100% of the thickness L₀ of the pad of sheets forming the refill 6, this width I advantageously being between 70 and 90% of L₀. When the width I is less than the thickness L₀, the spine portion 8a then has two free and flexible side strips 8e which are not covered by the magnets 9a, 9b and which connect to the side portions 8b.

Other arrangements are possible for the magnets, for example replacing each of the magnets 9a, 9b with two or more magnets placed beside one another along the width of the spine portion 8a. In this case, with a similar arrangement of the complementary magnetic elements 3a, 3b, a magnetic guiding effect can be obtained when attaching the cover 2 by choosing a different orientation of the polarities for the respective magnetic pairs.

Referring to FIGS. 3 and 4, the side portions 8b of the covering strip 8 can be divided into different longitudinal portions as follows:
a free and flexible intermediate portion 8c which laterally extends the spine portion 8a;
an end portion 8d which extends the intermediate portion 8c and which is attached for example by a layer of adhesive 11 to the corresponding main surface 6a, 6b of the pad of pages 6g.

While both side portions 8b are represented here as having a longitudinal attachment portion 8d whose width is significantly less than the width of the pages 6g in the pad, it is also possible to have side portions 8b which cover the entirety of the main surfaces 6a, 6b.

In the closed position represented in FIG. 4, one can specifically see that the free and flexible intermediate portion 8c has, in the extension of the end portion 8d, a first sub-portion whose width I₁ is sufficient to allow displacement of the pages 6g of the pad during their rotational movement relative to the magnets 9a, 9b, as will be explained below. This first sub-portion of width I₁ is held parallel to the pages 6g of the pad in the closed position. The remainder of the intermediate portion 8c defines, with the side strip 8e at the edge of the spine portion 8a, a second sub-portion of width I₂ (curvilinear width, as shown in FIG. 4) which is complementary to the first sub-portion of width I₁. In the closed position, this second longitudinal sub-portion of width I₂ forms a flexible connection between the spine portion 8a and the first sub-portion of width I₁. Preferably, the width I₂ is substantially greater than the thickness e of the magnets 9a, 9b, this thickness e being measured perpendicularly to the spine portion 8a.

As can be seen in FIGS. 5-7, the above arrangements allow the pages 6g to open easily, unhindered by the magnets 9a, 9b, so that the pages 6g can lie substantially flat when open, unlike a conventional binding.

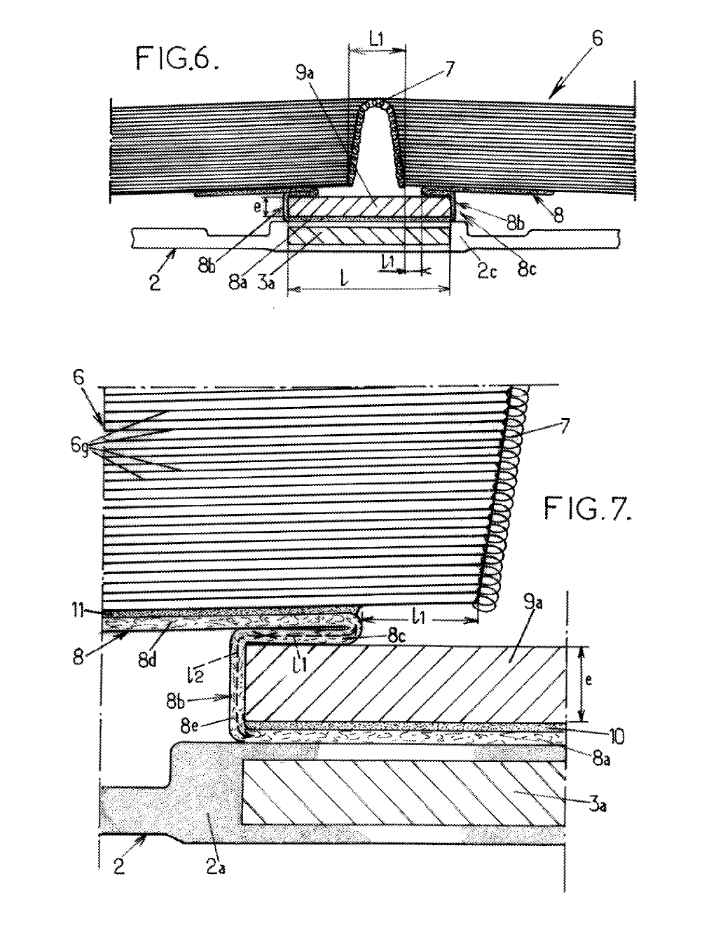

When a user opens the pages of the refill 6, the second sub-portion of width I₂ bends first, then the first sub-portion of width I₁ bends in turn to achieve the flat open position shown in FIGS. 5 to 7. This flat open position is permitted by the flexibility given to the binding 7 by the covering strip 8, which allows the binding 7 to conform to the arch of the open refill 6, as shown in FIGS. 6 and 7. In this position, the two lateral edges of the binding 7 (initially separated by thickness L₀ before opening) draw closer to one another until they are separated by a distance L₁ which can be less than L₀/3 for example.

It is understood that the narrowing of this distance increases with the width I₁. One can thus choose I₁ to be between ⅛ and ¼ of the width I of magnet 9a. This narrowing also increases with the free width I₂, which is particularly dependent on the width of the free side strips 8. To simplify, in this particular non-limiting example shown in FIGS. 6-7, we have the relation:

I=L₁+4.I₁+2.(I₂−e) (1)

Referring to FIGS. 6-7, when the refill 6 is in the open position, the sub-portion of width I₂ preferably covers at least the entire thickness of the adjacent side face of the magnet 9a or 9b. In addition, in this position, the sub-portion of width I₁ covers at least a portion of the face of the magnet 9a, 9b which is facing the binding 7. This sub-portion of width I₁ extends to a longitudinal folding region, which corresponds to where the intermediate free portion 8c and the end portion 8d connect.

It can be seen that after the pages 6g are opened, this reliably results in the complete folding of each of the foldable longitudinal portions 8c against the adjacent end portion 8d which remains attached to the pad of pages 6g. With this folding along the main surfaces 6a, 6b of the pad 6, the folding of the binding 7 is not prevented at the attachments to the spine portion 8a where the magnetic elements 9a, 9b are arranged.

In this first embodiment, the flexibility of the covering strip 8 is between the spine portion 8a and the end portion 8d. Of course, the flexibility may also be achieved by using only the sub-portion of width I₁ not attached to the pad of pages 6g or only the sub-portion of width I₂, possibly with the introduction of additional play by leaving space between the magnets 9a, 9b and the binding 7.

In this embodiment, the refill 6 has a compact shape and essentially comprises the pad of pages 6g with its binding 7, the covering strip 8, and the magnetic elements 9a, 9b. The refill 6 can thus have a substantially parallelepipedal volume when the pad of pages 6g is in the closed position. As can be seen in FIG. 3, the flaps 2e of the cover 2, equipped with complementary magnetic elements 2g, prevent the refill 6 from detaching, for example when there is an external impact on the spine 4 of the cover 2. Other non-magnetic devices, similarly located at the edge opposite the spine 4, may also be used to maintain the cover 2 in the closed position as an alternative to using flaps 2e and/or magnetic elements 2g in the flaps 2e.

Although the illustrated example shows a single refill 6 attached to the cover 2, it should be understood that multiple refills can be attached, one beside another. The refill 6 shown in FIG. 1 could therefore be replaced by two refills, each with magnetic elements 9a, 9b at the spine 6c which cooperate with the magnets 3a, 3b of the cover 2.

Furthermore, the cover 2 may include in its spine 2c a metal tab or a similar metal element arranged externally relative to the magnets 3a, 3b. This arrangement reduces the magnetic field beyond the stationery item 1. Such a metal tab further strengthens the magnetic attraction between the cover 2 and the refill or refills 6.

Although the spine 2c of the cover 2 is represented here as being flat, it is understood that the spine 2c may alternatively have a rounded profile. In this case, the inside face of the spine 2c is possibly concave and the magnets 3a, 3b have a rounded profile which may be similar to that of the spine 2c of the cover 2. The corresponding magnetic elements 9a, 9b of the refill 6 which allow attaching the refill 6 to the cover 2 may then have a convex surface of a shape complementary to the shape of magnets 3a, 3b.

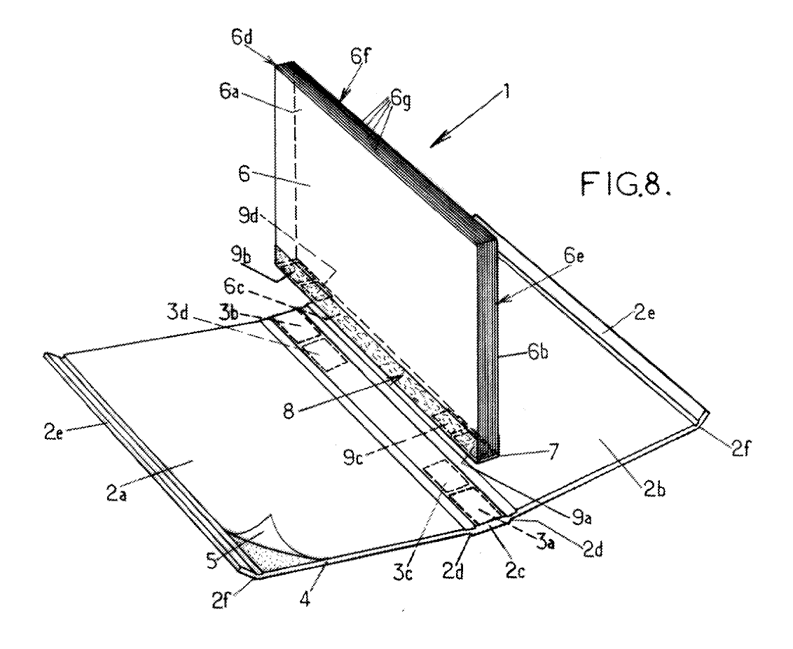

Three other embodiments will now be described with reference to FIGS. 8 to 10. Everything described above for the first embodiment applies to these alternative embodiments, which will therefore not be described in detail; only the differences between each of these other embodiments and the first embodiment will be described below.

### Second Embodiment

Referring to FIG. 8, the refill 6 is shown here as having a general form similar to the refill of the first embodiment, and essentially differs only in the number of similar magnets 9a, 9b, 9c, 9d or magnetic elements used. Here, four magnets 9a, 9b, 9c, 9d are arranged in alignment. Four magnets 3a, 3b, 3, 3d are then provided in the spine 2c of the cover, in a similar arrangement.

More generally, the number or shape of the magnetic elements can vary in order to implement the removable attachment by magnetic attraction to the spine 2c of the cover 2.

### Third and Fourth Embodiments

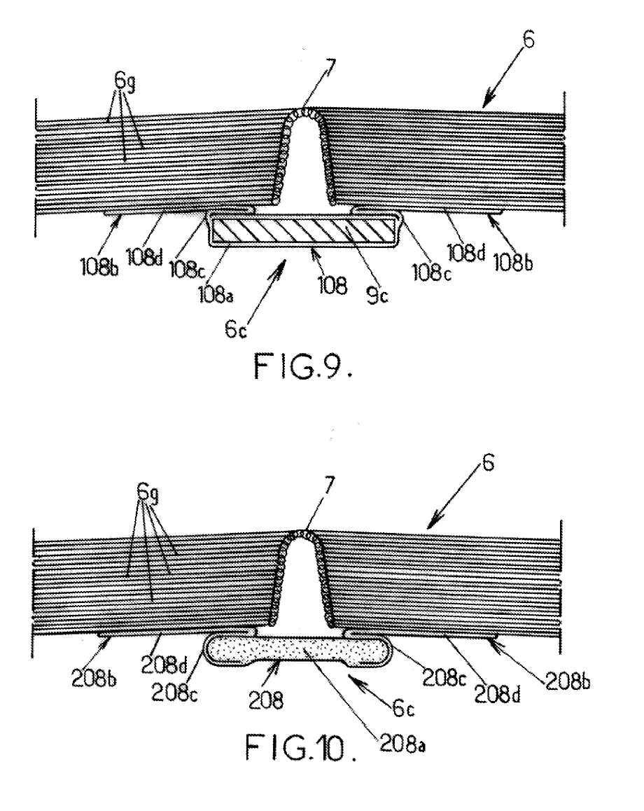

In the third embodiment (FIG. 9), the covering strip 108 may optionally be molded as a piece of thermoplastic material which wraps or overmolds the magnetic element or elements 9a, 9b. The side portions 108b are flexibly connected to the spine portion 108a which encloses the magnet or magnets 9a. Each of the side portions 108b includes, as above, a free intermediate portion 108c and an end portion 108d which is adhesively or otherwise bonded to the main surfaces 6a, 6b of the pad of pages 6.

In the fourth embodiment (FIG. 10), the magnetic material may also be incorporated into the composition of a covering strip 208 which can be attached by its side portions 208b to the main surfaces of the pad of pages 6g. In this case, the spine portion 208a is formed of a composite material with a powder of ferromagnetic material dispersed in a matrix. A magnetic element is thus obtained that is incorporated into the spine portion 208a and is manufactured as one part with the side portions 208b which are thinner and therefore more flexible than the spine portion 208.

The side portions 208b are flexibly connected to the spine portion 208a. As above, each of the side portions 208b includes an intermediate free portion 208c and an end portion 208d adhesively or otherwise bonded to the main surfaces 6a, 6b of the pad of pages 6.

In the examples in FIGS. 3 to 7, 9 and 10, which show the use of a refill 6, it can be seen that the covering strip 8, 108, or 208 is attached to the pad of pages 6g only by the side portions 8b, 108b, 208b. This configuration is also usable for stationery items 1 with a permanent attachment to the pad of pages 6g.

Indeed, the inventors have observed that to allow the pages 6g to open and lie flat, the configuration of a stationery item 1 with a covering strip 8, 108, 208 can be used regardless of the mode of attachment (removable or non-removable) of the pad of pages 6g. More particularly, a stationery item 1 can be proposed that comprises:
a cover 2 comprising at least a front cover board 2a, a back cover board 2b, and a spine 2c connecting the front and back cover boards 2a, 2b,
a pad of pages 6g, comprising a plurality of stacked pages, said pad of pages forming:
   two main outer surfaces 6a, 6b separated by a certain thickness L_{c}),
   a spine 6c defining said thickness on one side of the pad,
a binding 7 joining the pages 6g of the pad together at the spine 6c of the pad, - attachment means integral to the spine 2c of the cover 2, for attaching said plurality of pages 6g in a manner that allows them to turn relative to the spine 2c of the cover 2,
   wherein the attachment means comprises the flexible covering strip 8, 108, 208 which has:
a spine portion 8a, 108a, 208a externally covering the binding 7 and attached to the spine 2c of the cover 2, and
two side portions 8b, 108b, 208b respectively attached to the two main surfaces of the pad of pages 6g and connected to the spine portion 8a, 108a, 208a, and wherein the flexible covering strip 8, 108, 208 further has, at a connection between the spine portion 8a, 108a, 208a and one of the two side portions 8b, 108b, 208b, a free and flexible portion (8c, 108c, 208c, 8e) which is arranged between the spine 2c of the cover 2 and an attachment portion which is part of the side portion 8b, 108b, 208b, said attachment portion being attached to the corresponding main surface 6a, 6b of the pad of pages 6g, said free and flexible portion (8c, 108c, 208c, 8e) not being attached to the spine 2c of the cover 2 or to the pad of pages 6g or to the binding 7.

According to another feature of the invention, the free and flexible portion (8c, 108c, 208c, 8e) completely covers a ridge formed between the spine 6c of the pad of pages 6g and one of the main surfaces 6a, 6b.

1. A refill for stationery item, comprising:
a pad of pages, comprising a plurality of stacked pages, said pad of pages forming two main outer surfaces separated by a certain thickness,
a spine defining said thickness at one side of the pad,
a binding that binds the pages of the pad together at the spine,
magnetic means, arranged at the spine of the pad and Configured to attach by magnetic attraction to a cover of the stationery item,
a flexible covering strip having:
a spine portion which externally covers the binding, and
two side portions which are respectively attached to the two main outer surfaces of the pad of pages and are connected to the spine portion,
wherein the spine portion of the covering strip is provided with said magnetic means to define all or part of the spine of the refill.

2. The refill according to claim 1, wherein the magnetic means comprise a ferromagnetic material.

3. The refill according to claim 2, wherein said ferromagnetic material is permanently magnetized.

4. The refill according to claim 2, wherein said ferromagnetic material is a metal.

5. The refill according to claim 1, wherein the covering strip is less than 1 mm in thickness.

6. The refill according to claim 1, wherein the magnetic means comprise at least one magnetic element integral with the spine portion of the covering strip.

7. The refill according to claim 6, wherein the spine portion of the covering strip has a certain thickness and said magnetic element is included within said thickness.

8. The refill according to claim 6, wherein said magnetic element is attached to the spine portion of the covering strip facing the binding of said pad.

9. The refill according to claim 7, wherein the spine portion of the covering strip is integral with at least two magnetic elements spaced apart along the spine of the refill.

10. The refill according to claim 9, wherein the magnetic elements are arranged asymmetrically on the spine of the refill relative to a 180° rotation of the refill about an axis perpendicular to the spine of the refill.

11. The refill according to claim 9, wherein the magnetic elements are permanent magnets with non-parallel polarization relative to each other.

12. The refill according to claim 1, wherein the magnetic means comprise at least one magnetic material integrated into the material of the spine portion of the covering strip.

13. The refill according to claim 1, wherein each of the two side portions of the covering strip comprises:
a free and flexible intermediate portion which extends laterally from the spine portion and is not attached to the corresponding main outer surface of the pad of pages, and
an end portion which extends from said intermediate portion and is attached to said corresponding main outer surface of the pad of pages.

14. The refill according to claim 1, wherein the spine portion of the covering strip has a certain width and the magnetic means comprise at least one rigid magnetic element which extends over a width that is less than the width of the spine portion, the spine portion having two free and flexible side strips which are not covered by said magnetic element and which connect to said side portions of the covering strip.

15. A stationery item comprising:
a refill that comprises a spine, a pad of pages, a binding that binds the pages of the pad together,
a cover comprising at least a front cover board, a back cover board, and a cover spine connecting the front and back cover boards, the cover spine being provided with magnetic means, wherein the pad of pages comprises a plurality of stacked pages, said pad of pages forming two main outer surfaces separated by a certain thickness,
wherein the refill further comprises:
an arrangement of magnetic elements, extending along the spine of the refill and configured to be attracted by the magnetic means of the cover, to allow the spine of the refill to be attached to the cover by magnetic attraction,
a flexible covering strip having:
a spine portion which externally covers the binding, and
two side portions which are respectively attached to the two main outer surfaces of the pad of pages and are connected to the spine portion,
and wherein the spine portion of the covering strip and said arrangement of magnetic elements form the spine of the refill.

16. (canceled)

17. The item according to claim 15, wherein the magnetic elements of the refill comprise a plurality of magnetic elements integral with the spine portion of the covering strip and the cover spine comprises a plurality of complementary magnetic elements each configured for magnetically attracting a magnetic element of the refill and arranged in correspondence with said magnetic element of the refill.

18. The item according to claim 15, wherein the binding extends in a separated manner from the flexible covering strip so that the binding can be folded at a distance from the spine portion of the flexible strip.

19. A stationery item comprising:
a refill that comprises a spine, a pad of pages, a binding that binds the pages of the pad together,
a cover comprising at least a front cover board, a back cover board, and a cover spine connecting the front and back cover boards, the cover spine being provided with magnetic means ,
wherein the pad of pages comprises a plurality of stacked pages, said pad of pages forming two main outer surfaces separated by a certain thickness,
wherein the refill further comprises:
at least one inner magnetic element, provided along the spine of the refill and configured to be attracted by the magnetic means of the cover, to allow the spine of the refill to be attached to the cover by magnetic attraction,
a flexible covering strip having:
a spine portion which externally covers the binding, and
two side portions which are respectively attached to the two main outer surfaces of the pad of pages and are connected to the spine portion,
and wherein the spine of the refill comprises:
an outer layer defined by the spine portion of the covering strip, and
an inner layer including said at least one inner magnetic element.

20. The item according to claim 19, wherein the binding extends in a separated manner from the flexible covering strip so that the binding can be folded at a distance from the spine portion of the flexible strip.
